(19) United States
(12) Patent Application Publication
(10) Pub. No.: US 2004/0049968 A1
(43) Pub. Date: Mar. 18, 2004

(54) Fishing pole strap

(76) Inventor: Lawrence Barginear, Muskegon, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/458,097

(22) Filed: Jun. 10, 2003

Related U.S. Application Data
(60) Provisional application No. 60/411,637, filed on Sep. 18, 2002.

(51) Int. Cl. A01K 97/08

(52) U.S. Cl. 43/26

(57) ABSTRACT

A retainer for organizing a plurality of lengths of fishing rod includes a flexibly-resilient member having a first end and a second end including at least one tab. The retainer also includes a first portion of a coupler fixedly attached to the flexibly resilient member proximate the first end thereof, and a second portion of coupler fixedly attached to the flexibly resilient member at a point along the length of the flexibly resilient member located between the first end and the at least one tab. The flexibly resilient member is adapted to be wrapped about a plurality of aligned lengths of fishing rod, wherein the second portion of the coupler is coupled to the first portion of the coupler, thereby retaining the length of fishing rod in close relationship.

### CROSS-REFERENCE TO RELATED APPLICATION

This application claims the benefit of U.S. Provisional Application No. 60/411,637, filed Sep. 13, 2002, entitled THE FISHING POLE MATE, which is hereby incorporated herein by reference in its entirety.

### BACKGROUND OF THE INVENTION

The present invention relates to an organizer for fishing equipment, and in particular to a plurality of straps for organizing lengths of fishing rod.

A wide variety of organizers for lengths of fishing rod are known in the art. One of the main purposes of these organizers is to prevent the rods and associated fishing line from being entangled during transport. Typically, these organizers include rigid or flexible housings or cases within which a broken down or dismantled fishing rod is stored. These housings or cases can be difficult to manipulate, and require a significant storage area within a vehicle when being transported. Further, these systems can be relatively expensive. Another method of organizing fishing rods includes taping the rods together. However, this method can be cumbersome, time consuming and result in adhesive resins remaining on the rod.

A relatively inexpensive retainer system for organizing lengths of fishing rod or multiple fishing poles that serve to solve the above-referenced shortfalls and problems is desired.

### SUMMARY OF THE INVENTION

One aspect of the present invention is to provide a retainer for organizing a plurality of lengths of fishing rod includes a flexibility-resilient member having a first end and a second end including at least one tab. The retainer also includes a first portion of a coupler fixedly attached to the flexibly resilient member proximate the first end thereof, and a second portion of the coupler fixedly attached to the flexibly resilient member at a point along a length of the flexibly resilient member located between the first end and the at least one tab. The flexibly resilient member is adapted to be wrapped about a plurality of aligned lengths of fishing, wherein the second portion of the coupler is adapted to couple to the first portion of the coupler, thereby retaining the lengths of fishing rod in close relationship.

Another aspect of the present invention is to provide a retainer system for organizing a plurality of lengths of fishing rod that includes a plurality of retainers, each retainer including a flexibly resilient member having a first end and a second end including at least one tab, a first portion of a coupler fixedly attached to the flexibly resilient member proximate the first end thereof, and a second portion of the coupler fixedly attached to the flexibly resilient member at a point along a length of the flexibly resilient member located between the first end and the at least one tab. The distance between the first coupler and the second coupler defines a coupling length.

The flexibly resilient member is adapted to be wrapped about a plurality of aligned lengths of fishing rod, wherein the second portion of the coupler is adapted to couple to the first portion of the coupler, thereby retaining the lengths of fishing rod in close relationship. The coupling length of the flexibly resilient member of each of the retainers is different than the other retainers.

Yet another aspect of the present invention is to provide a method for organizing a plurality of lengths of fishing rod including providing a plurality of retainers, wherein each retainer comprises a flexibly resilient member having a first end and a second end including at least one tab, a first portion of a coupler fixedly attached to the flexibly resilient member proximate the first end thereof, and a second portion of the coupler fixedly attached to the flexibly resilient member at a point along the length of the flexibly resilient member located between the first end and the at least one tab. The method also includes wrapping the flexibly resilient member of each retainer about the lengths of the fishing rod, and coupling the first portion of the coupler of each flexibly resilient member to the second portion of the coupler of each flexibly resilient member.

The present inventive retainer, retainer system, and related method is durable, includes an uncomplicated design, results in a reduced manufacturing costs as compared to prior storage cases, can be easily and quickly operated, is efficient to use, economical to manufacture, capable of a long operating life, and particularly well adapted for the proposed use. These and other advantages of the invention will be further understood and appreciated by those skilled in the art by reference to the following written specification, claims and appended drawings.

### BRIEF DESCRIPTION OF THE DRAWINGS

FIG. 1 is a perspective view of a retainer system embodying the present invention, and organizing a plurality of lengths of fishing rod; and

FIG. 2 is a perspective view of a retainer of the retainer system shown in an uncoupled orientation.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

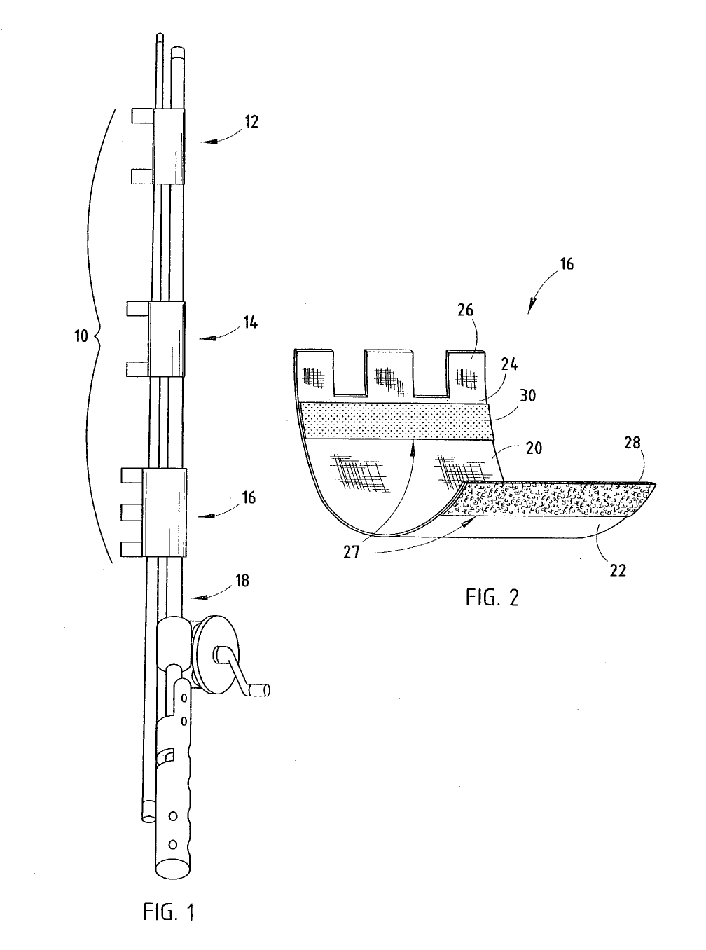

The reference numeral 10 (FIG. 1) generally designates a retainer system embodying the present invention. The retainer system 10 includes a plurality of retainers 12, 14, 16 spaced along a plurality of lengths of fishing rod 18 and organizing the same. It should be noted that while a single broken-down or dismantled fishing rod 18 is shown in the illustrated example, the retainer system 10 may be utilized to organize a plurality of different and complete fishing poles. The retainers are preferably constructed of a flexibly and elastically deformable material suitable for such an application.

Each of the retainers 12, 14, 16 are substantially similar. Therefore, the following description of retainer 16 should be considered descriptive of each and every one of the retainers 12, 14, 16. The retainer 16 (FIG. 2) includes a flexibly-resilient member or body portion 20 having a first end 22 and a second end 24. The body 20 is preferably elastically-resilient along a length thereof. The second end 24 defines a plurality of tabs 26 spaced across the width of the retainer 16. It should be noted that the tabs 26 may be replaced by a single tab or flap extending across the entire width of the retainer 16. The retainer 16 also includes a coupler 27 having a first half of a hook-and-loop type fastener 28 fixedly attached thereto. The coupler 27 also includes a second half of a hook-and-loop type fastener 30 fixedly attached to the flexibly resilient member 20 at a location located between the first end 22 and the plurality of tabs 26, thereby allowing grasping of the tabs 26 by the user, as described below. It should be noted that while the illustrated example includes a hook-and-loop type fastener, other fasteners suitable for such an application may be utilized. The retainers 12, 14, 16 are preferably provided with the dimensions of about 2.25 inches by about 3.125 inches, about 2.25 inches by about 3.75 inches, and 2.75 inches by about 5.125 inches.

In operation, the subject fishing rod 18 is broken down or disassembled into its individual components. These individual components or lengths of fishing rod are then bunched together and organized or strapped together via the retainers 12, 14, 16. Specifically, the flexibly resilient member or body 20 of each retainer 12, 14, 16 is wrapped about the plurality of aligned lengths of fishing rod 18. The body portion 20 of each retainer 12, 14, 16 is then stretched along a length thereof, and the second portion 30 of the coupler 27 is coupled to the first portion 28 of the coupler 27, thereby retaining the lengths of fishing rod 18 in a close and organized relationship. The operator or user can then access the fishing rod 18 by uncoupling the first and second portions 28 and 30 of the coupler 27 by grasping the tabs 26 and pulling away or uncoupling the coupler.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A retainer for organizing a plurality of lengths of fishing rod, comprising:
a flexibly resilient member having a first end and a second end including at least one tab;
a first portion of a coupler fixedly attached to the flexibly resilient member proximate the first end thereof; and
a second portion of the coupler fixedly attached to the flexibly resilient member at a point along a length of the flexibly resilient member located between the first end and the at least one tab;
wherein the flexibly resilient member is adapted to be wrapped about a plurality of aligned lengths of fishing rod, and wherein the second portion of the coupler is adapted to couple to the first portion of the coupler, thereby retaining the lengths of fishing rod in close relationship.

2. The retainer of claim 1, wherein the first and second couplers include hook-and-loop type fasteners.

3. The retainer of claim 2, wherein the hook-and-loop type fasteners extend substantially across an entire width of the flexibly resilient member.

4. The retainer of claim 3, wherein the at least one tab includes a plurality of tabs spaced across the width of the flexibly resilient member.

5. The retainer of claim 4, wherein the flexibly resilient member is elastically resilient along a length thereof.

6. The retainer of claim 1, wherein the first coupler and the second coupler extend substantially across an entire width of the flexibly resilient member.

7. The retainer of claim 1, wherein the at least one tab includes a plurality of tabs spaced across a width of the flexibly resilient member.

8. The retainer of claim 1, wherein the flexibly resilient member is elastically resilient along a length thereof.

9. A retainer system for organizing a plurality of lengths of fishing rod, comprising:
a plurality of retainers, each retainer comprising:
a flexibly resilient member having a first end and a second end including at least one tab;
a first portion of a coupler fixedly attached to the flexibly resilient member proximate the first end thereof; and
a second portion of the coupler fixedly attached to the flexibly resilient member at a point along a length of the flexibly resilient member located between the first end and the at least one tab;
wherein the distance between the first coupler and the second coupler defines a coupling length, the flexibly resilient member is adapted to be wrapped about a plurality of aligned lengths of fishing rod, and wherein the second portion of the coupler is adapted to couple to the first portion of the coupler, thereby retaining the lengths of fishing rod in close relationship;
wherein the coupling length of the flexibly resilient member of each of the retainers is different.

10. The retainer system of claim 9, wherein the first second couplers include hook-and-loop type fasteners.

11. The retainer system of claim 10, wherein the hook-and-loop type fasteners extend substantially across an entire width of the flexibly resilient member.

12. The retainer system of claim 11, wherein the at least one tab includes a plurality of tabs spaced across the width of the flexibly resilient member.

13. The retainer system of claim 12, wherein the flexibly resilient member is elastically resilient along a length thereof.

14. The retainer of claim 9, wherein the first coupler and the second coupler extend substantially across an entire width of the flexibly resilient member.

15. The retainer of claim 9, wherein the at least one tab includes a plurality of tabs spaced across a width of the flexibly resilient member.

16. The retainer of claim 9, wherein the flexibly resilient member is elastically resilient along a length thereof.

17. A method for organizing a plurality of lengths of fishing rod, comprising:
providing a plurality of retainers, wherein each retainer comprises a flexibly resilient member having a first end and a second end including at least one tab, a first portion of a coupler fixedly attached to the flexibly resilient member proximate the first end thereof, and a second portion of the coupler fixedly attached to the flexibly resilient member at a point along a length of the flexibly resilient member located between the first end and the at least one tab;
wrapping the flexibly resilient member of each retainer about the lengths of fishing rod; and
coupling the first portion of the coupler of each flexibly resilient member to the second portion of the coupler of each flexibly resilient member.

18. The method of claim 6, further comprising:
elastically flexing the flexibly resilient member of each of the retainers along a length thereof before coupling the first and second portions of the coupler of each retainer.
